(19) United States
(12) Patent Application Publication
(10) Pub. No.: US 2007/0269262 A1
(43) Pub. Date: Nov. 22, 2007

(54) Connector for timber construction

(76) Inventor: Peter Bertsche, Prackenbach (DE)

Correspondence Address: BACON & THOMAS, PLLC, 625 SLATERS LANE, FOURTH FLOOR, ALEXANDRIA, VA, 22314, US

(21) Appl. No.: 11/730,239

(22) Filed: Mar. 30, 2007

(30) Foreign Application Priority Data
Mar. 31, 2006 (DE) 10 2006 015 122.4

(51) Int. Cl. F16B 13/00

(52) U.S. Cl. 403/267

(57) ABSTRACT

The connectors comprise a connector anchored in an end-face blind bore in a wooden beam, which includes the following features: a cylindrical insert whose diameter corresponds approximately to the diameter of the blind bore and which has peripheral recesses or grooves formed tangentially in the cylinder surface; bar dowels which are incorporated perpendicular to the longitudinal plane of the connector and the wooden beam and which penetrate the recesses or grooves of the insert so as to lie at least partly within the outline of the cylinder surface; some of the bar dowels are provided with a wooden thread; a rigid sealing compound body in the blind bore, which surrounds the cylindrical insert and the bar dowels and forms with said parts a composite block, and a connecting member formed on the connector for anchoring in, or connection to, another body. This connector makes it possible to realize wood constructions with high load-capacity.

This invention relates to a connector for timber construction, the invention relating more precisely to a connector anchored in a blind bore in a wooden beam.

In wood constructions, load-transmitting connectors are needed that withstand strong tensile loads, primarily in the longitudinal direction of the wooden beams to be connected. It is important that said connectors are highly loadable, simple and economical to produce, and permit quick and simple assembly.

EP 0 263 350 discloses a connector anchored in a blind bore in a wood component. It consists of an insert incorporated in the longitudinal direction of the blind bore, bar dowels incorporated perpendicular thereto into the wood and partly penetrating the outline of the insert, a rigid sealing compound body in the blind bore, which surrounds the insert and the bar dowels and forms with said parts a composite block, and a connector for connection to other bodies.

This connector substantially fulfills the requirements stated above. However, there is still the disadvantage that the transverse tensile forces occurring in the introducing area of the wood component can lead to splitting of the cross section of the wooden beam and thus to breakage thereof.

It is the problem of the present invention to optimize connectors for timber construction in such a way that additionally the transverse tensile strength in the introducing area of the wood is considerably increased.

This problem is solved by an apparatus having the features of claim 1. Advantageous embodiments and developments of the invention are stated in dependent claims.

The present invention comprises a connector anchored in an end-face blind bore in a wooden beam, which includes the following features: a cylindrical insert whose diameter corresponds approximately to the diameter of the blind bore and which has peripheral recesses or grooves formed tangentially in the cylinder surface; bar dowels which are incorporated perpendicular to the longitudinal plane of the connector and the wooden beam and which penetrate the recesses or grooves of the insert in such a way as to lie at least partly within the outline of the cylinder surface; a rigid sealing compound body in the blind bore, which surrounds the cylindrical insert and the bar dowels and forms with said parts a composite block, and a connecting member formed on the connector for anchoring in, or connection to, another body.

The basic idea of the present invention is to provide some of the bar dowels serving to anchor the insert in the wooden beam, with a wooden thread and to screw said bar dowels into the wooden beam. This results in the advantage of considerably increasing the transverse tensile strength in the introducing area of the wood. In this way, breakage of the wooden beam by splitting of the cross section can be avoided.

It is preferably provided that the bar dowels provided with the wooden thread are incorporated primarily at the end of the wooden beam near the head, since this is where the strongest transverse tensile forces occur.

The assembly of the connector remains simple and can be carried out quickly. The bar dowels provided with the wooden thread are preferably screwed into pre-drilled holes having the diameter of the core diameter of the bar dowels, whereby the thread cuts itself into the wood.

For easy screwing in, the bar dowels provided with the wooden thread are preferably provided on one side with a hexagon socket for example.

The bar dowels provided with the wooden thread can have a greater total cross section than conventional bar dowels hitherto used, which results in greater flexural stiffness. This further increases the load bearing capacity of the connector.

The invention will hereinafter be explained by way of example with reference to the enclosed drawing. The figures are described as follows:

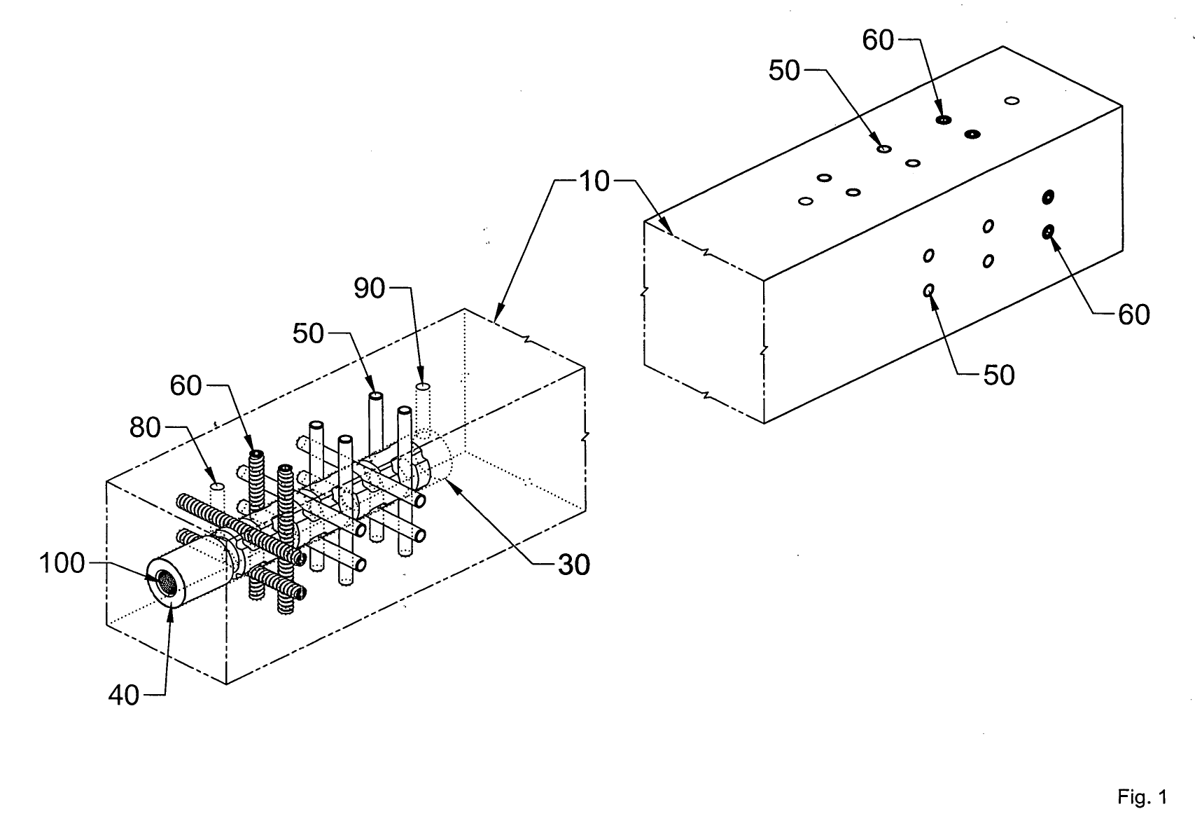

FIG. 1 a perspective view of a connector anchored in a wooden beam,

FIG. 2 a bar dowel with a wooden thread,

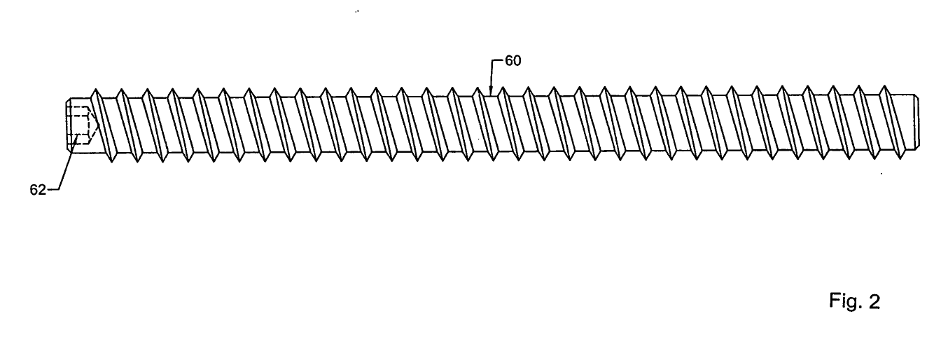

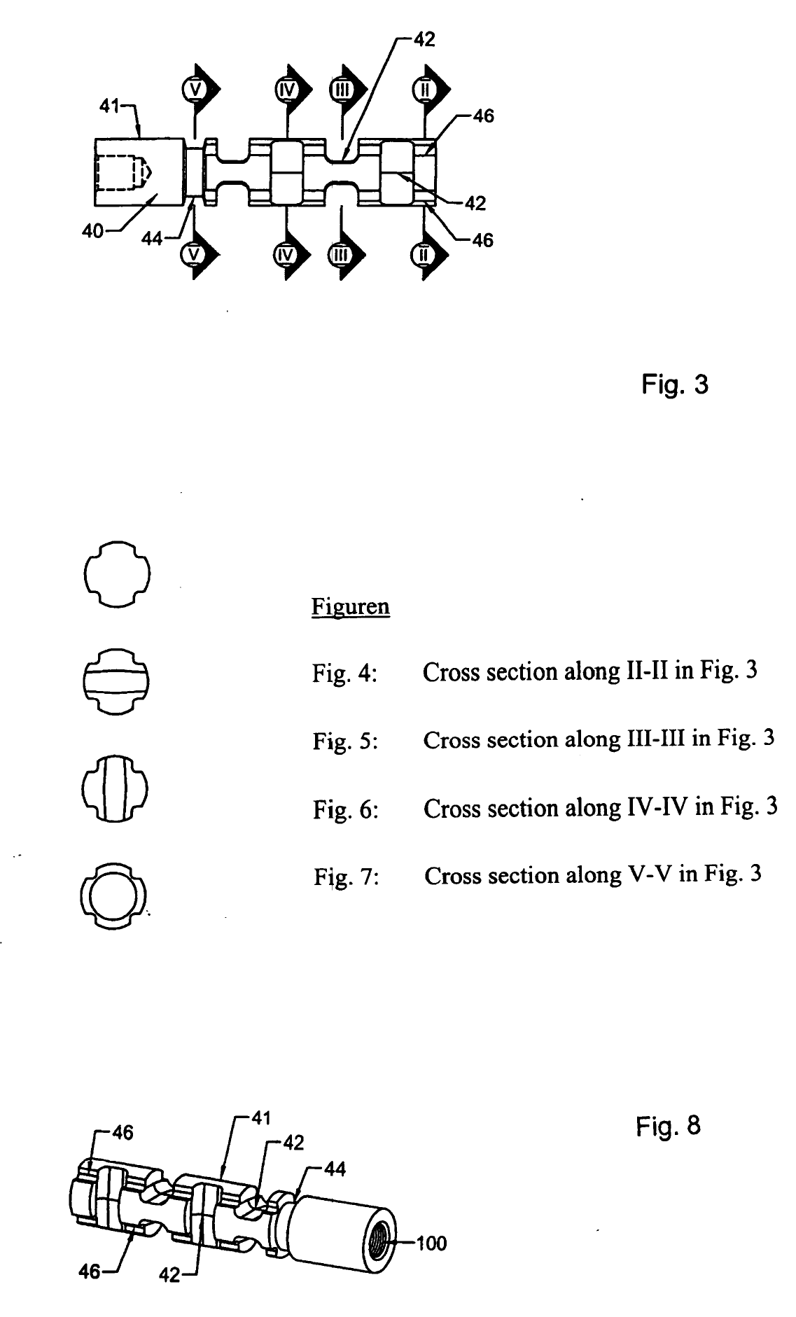

FIG. 3 a cylindrical insert in a side view,

FIG. 4 a cross section of the insert from FIG. 3, taken along the line II-II,

FIG. 5 a cross section of the insert from FIG. 3, taken along the line III-III,

FIG. 6 a cross section of the insert from FIG. 3, taken along the line IV-IV,

FIG. 7 a cross section of the insert from FIG. 3, taken along the line V-V, and

FIG. 8 a perspective view of a cylindrical insert.

An embodiment of the present invention will be set forth hereinafter more exactly. FIG. 1 shows a perspective view of a connector anchored in an end-face blind bore 30 in a wooden beam 10. A cylindrical insert 40 whose cross section corresponds approximately to that of the blind bore 30 is incorporated into the wooden beam 10 in the longitudinal direction of the blind bore 30. Ordinary bar dowels 50 and bar dowels 60 provided with a wooden thread are incorporated into the wooden beam 10 in a plane perpendicular to the longitudinal direction of the insert 40 and penetrate tangential peripheral recesses in the surface side of the insert 40 in such a way that they, the bar dowels, lie at least partly within the outline of the insert 40. The sealing compound for forming the rigid sealing compound body (not shown) has been incorporated through the sealing bore 80, surplus air has escaped through the ventilation bore 90 upon filling; the two bores each open into the blind bore 30. A connecting member 100 is formed at the head end of the insert, for example as a thread.

FIG. 2 shows a side view of a bar dowel 60 provided with a wooden thread, which is provided on one side with a hexagon socket 62 for easy screwing into the wooden beam.

FIG. 3 shows a side view of a cylindrical insert 40. In connection with the present invention, prism-shaped inserts with a polygonal base are cylindrical according to the invention. Recesses 42 and grooves 44 formed tangentially in the cylinder surface 41, as well as gaps 46, permit the sealing compound to flow through uniformly and fill all cavities of the blind bore during filling.

FIGS. 4 to 7 show different cross sections of the insert from FIG. 3. FIG. 4 shows a cross section along the line II-II showing the gaps permitting the sealing compound to flow through. FIG. 5 shows a cross section along the line III-III showing an embodiment of the recesses 42 disposed in pairs. FIG. 6 shows a cross section, taken along the line IV-IV, showing recesses like those from FIG. 5 rotated by 90° around the longitudinal axis of the insert. Finally, FIG. 7 shows a cross section along the line V-V illustrating a circumferentially running groove. In conclusion, FIG. 8 shows a perspective view of a cylindrical insert again indicating different features such as the peripheral recesses 42, the gaps 46 and the connecting member 100 formed as a thread.

In this embodiment, the bar dowels 50, 60 are disposed in pairs, parallel to each other on opposite sides of the insert 40 in a plane perpendicular to the longitudinal direction of the insert 40. Each pair is rotated by an angle of 90° around the longitudinal axis of the insert 40 in comparison with the adjacent pairs, but other rotation angles can also be used if the wooden beam has a different base for example.

In this embodiment, it is provided that the bar dowels 60 provided with the wooden thread are incorporated primarily at the end of the wooden beam 10 near the head, since this is where the strongest transverse tensile forces occur.

The assembly of the inventive connector can be carried out very simply and fast. After a blind bore 30 and, opening thereinto, the sealing bore 80 and the ventilation bore 90 are formed in the wooden beam 10, the cylindrical insert 40 is incorporated into the blind bore. After the conventional bar dowels 50 are driven in and the bar dowels 60 provided with the wooden thread are screwed in perpendicular to the longitudinal direction of the blind bore, the sealing compound is pressed into the sealing bore 80. After the quickly effected curing of the sealing compound, the connector is ready for further work on the wooden beam 10.

1. A connector anchored in an end-face blind bore in a wooden beam, comprising:
a) a cylindrical insert whose diameter corresponds approximately to the diameter of the blind bore;
b) peripheral recesses or grooves formed tangentially in the cylinder surface of the insert;
c) bar dowels which are incorporated perpendicular to the longitudinal plane of the connector and the wooden beam and which penetrate the recesses or grooves of the insert in such a way as to lie at least partly within the outline of the cylinder surface;
d) a rigid sealing compound body in the blind bore, which surrounds the cylindrical insert and the bar dowels and forms with said parts a composite block, and
e) a connecting member formed on the connector for anchoring in, or connection to, another body,
wherein at least one of the bar dowels has a wooden thread and is screwed into the wooden beam.

2. The connector according to claim 1, wherein the bar dowels provided with the wooden thread are incorporated at the end of the wooden beam near the head.

3. The connector according to claim 1, wherein the bar dowels provided with the wooden thread are incorporated into the wooden beam in pairs parallel to each other on opposite sides of the longitudinal axis of the cylindrical insert and in a plane perpendicular to said longitudinal axis.

4. The connector according to claim 3, wherein a plurality of pairs of bar dowels provided with the wooden thread are incorporated into the wooden beam adjacently and each rotated by an angle around the longitudinal axis of the cylindrical insert.

5. The connector according to claim 1, wherein the bar dowels provided with the wooden thread are provided on one side with a hexagon socket.

6. The connector according to claim 1, wherein the peripheral recesses are formed in the side surface of the insert by pairs of indentations opposite each other relative to the longitudinal axis of the cylindrical insert in a plane perpendicular to the longitudinal direction of the cylindrical insert.

7. The connector according to claim 1, wherein the peripheral recesses in the side surface of the insert comprise a plurality of notches located on a helical line along the surface of the cylindrical insert.

8. The connector according to claim 1, wherein the insert is formed as a forged part or cast steel part.
